(19) United States
(12) Patent Application Publication
(10) Pub. No.: US 2002/0197345 A1
(43) Pub. Date: Dec. 26, 2002

(54) Method and device for ultrasound treatment of a fabric

(76) Inventors: Klaus Kubik, Tonisvorst (DE); Bernhard Funger, Krefeld (DE); Kay Knorre, Krefeld (DE); Achim Wandke, Kempen (DE)

Correspondence Address: KENYON & KENYON, ONE BROADWAY, NEW YORK, NY, 10004, US

(21) Appl. No.: 10/174,839

(22) Filed: Jun. 19, 2002

(30) Foreign Application Priority Data
Jun. 21, 2001 (DE) 101 29 470.0

(51) Int. Cl. B29C 35/10; B29C 65/08

(52) U.S. Cl. 425/174.2; 83/956; 156/73.3; 156/580.2; 264/442; 264/445; 264/483; 425/174

(57) ABSTRACT

A method for ultrasound treatment of at least one fabric. The fabric is passed through a working gap between a sonotrode connected with an ultrasound vibration unit and a counter-tool, and is exposed to an ultrasound effect in the working gap. The fabric or fabrics to be treated are subjected to pretreatment in a device before passing through the working gap.

### FIELD OF THE INVENTION

The invention relates to a method and to a device for ultrasound treatment of a fabric.

### BACKGROUND MATERIAL

German Patent No. 44 39 284 C2 describes a sonotrode connected with an ultrasound vibration unit. The sonotrode serves as a type of punch that vibrates radially to a counter-tool, which is structured as a rotating engraved roller. A fabric is guided through the working gap between the sonotrode and the counter-tool. The fabric can be made up of a strip-shaped nonwoven fabric made of thermoplastic fibers, or of several strips to be bonded together, at least one of which must demonstrate thermoplastic properties. Because of the high-frequency compressions that the material undergoes between the peaks of the engravings of the counter-roller and the face of the sonotrode, local temperature increases occur, up to plastification of the thermoplastic fibers, i.e. the thermoplastic material. In this way, an individual fabric that is passed through can be bonded, or a perforation can be achieved in it by local melting. In the case of several fabrics that are passed through the working gap, these can be bonded together.

Since the treatment effect—whether it is bonding within a fabric, perforation, or bonding of several fabrics—is always brought about by friction-induced heating up to plastification of the thermoplastic material, it is understood that the introduction of energy to a certain location of the fabric while passing through the working gap is critical for achieving the desired treatment effect. In addition, it is understood that the maximum processing speed that can be achieved is limited by the energy required to be introduced in the working gap in order to achieve the treatment effect.

In order to increase the processing speed, German Patent No. 198 57 444 A1 describes a method and a device in which at least one of the interacting elements—sonotrode, fabric, counter-tool—can be heated, in order to reduce the amount of energy that must be introduced in order to achieve the desired treatment effect as the fabric passes through the working gap.

### SUMMARY OF THE INVENTION

The present invention describes a method and a device for ultrasound treatment of a fabric whereby the treatment result that can be achieved is improved while the processing speed remains the same, or whereby the processing speed can be increased while the treatment result remains qualitatively the same.

It has surprisingly been shown that the treatment result can be improved, e.g., the processing speed can be increased, if the fabric or one of the fabrics that is/are treated in the working gap is/are subjected to pretreatment that conditions the fabric, e.g., its surface, before entry into the working gap.

The pretreatment step may, in one embodiment of the present invention, include a treatment step involving the application of agents that activate the surfaces of the fabrics to be treated, in the sense of plastification and/or bonding at a lower introduction of energy.

Alternatively, or in addition to the above-described step, the pretreatment step may include a treatment step of ion irradiation, for example by corona discharge.

Furthermore, again as an alternative or in addition to the above described steps, agents can be applied that have an energy effect on the ultrasound effect in the working gap. Such agents can be liquids such as water or emulsions, for example, which evaporate under the ultrasound effect, thereby absorbing the heat of evaporation, and thereby resulting in a cooling effect of the fabric or fabrics to be treated as the fabric or fabrics pass through the working gap.

In this connection, it is particularly advantageous if the boiling point of the liquid being used, in each instance, is adapted to the plastification temperature(s) of the fabric(s) to be treated.

Furthermore, the method according to the present invention, as an alternative or in addition to the above-described steps, may include the application of agents that influence the friction between the at least one sonotrode and the side of the fabric that faces it and lies closest to the working gap. These agents can include, for example, silicone.

Furthermore, again as an alternative or in addition to the above-described steps, agents may be applied to the fabric to be processed, during the pretreatment step, which cool the sonotrode and/or the counter-tool during passage through the working gap.

The device suitable for implementing the method according to the present invention includes at least one device configured to pretreat a fabric prior to the fabric entering the working gap.

This device preferably includes at least one application unit for applying powdered, viscous, liquid and/or gaseous agents onto the fabric or one of the fabrics.

Furthermore, the device may include at least one unit for ion irradiation of the fabric or at least one of the fabrics.

### BRIEF DESCRIPTION OF THE DRAWINGS

FIG. 1 illustrates schematically a side view of an exemplary embodiment of a device according to the present invention, for ultrasound treatment of at least one fabric.

### DETAILED DESCRIPTION

In the embodiment shown, the device 100 is configured to bond together two fabrics 1, 1′, which have the structure, for example, of a nonwoven fabric made of thermoplastic fibers and a film to be attached to it by bonding. In the exemplary embodiment shown in the drawing, fabrics 1, 1′ are made up of strips of material that are each transported in the direction of the arrows P, P′.

Above fabric 1, a number of sonotrodes that lie directly next to one another crosswise to the strip of fabric 1 is provided, which transfer the ultrasound vibrations to fabric 1, 1′. In the drawing, only lower part 2′ of sonotrode 2 is shown. Sonotrode 2 is coupled with an ultrasound vibration unit above the part shown. Sonotrode 2 has a lengthwise center plane 3; the axis 4 of a rotating counter-roller 5 that forms the counter-tool and supports fabrics 1, 1′ against sonotrode 2 from below lies in said plane. On the side facing fabrics 1, 1′, sonotrode 2 has a face 2, 2′ that can be flat, or non-flat, for example as shown, a concave cylindrical structure with an axis that coincides with axis 4 of counter-roller 5. Face 2, 2′ is approximately parallel to the top of fabric 1 and rests on it.

Sonotrode 2, with its face 2, 2′, and the circumference of counter-roller 5, between them form a working gap 7, through which fabrics 1, 1′ are passed in the direction of arrows P, P′. On its circumference, counter-roller 5 has an engraving 6, which corresponds to the bonding or cutting pattern, and on peaks 6′ of which preferential compression of the materials of the fabrics and a preferential effect of the ultrasound vibrations take place, resulting in a preferential temperature increase and plastification at these locations. In this way, the materials of the fabrics are bonded together in a pattern that corresponds to the location of the peaks 6′.

To achieve the desired treatment effect, it is important, first of all, to control the degree of compression of the materials of fabrics 1, 1′ between the peaks of engraving 6 and face 2, 2′ of sonotrode 2 very precisely. If counter-roller 5 bends under the forces that are in effect in the working gap, the distance from sonotrodes 2 in the center of the strip width increases, and the effect of the ultrasound, for example, bonding of the nonwoven fabric, decreases there. For this reason, counter roller 5 is structured as a deflection-controlled roller, with a hollow roller 8 that rotates around an axis 4, perpendicular to the plane of the drawing. The hollow roller 8 has a non rotating stationary crosshead 9 passing through its length, which is rigidly attached to the machine at its ends. In stationary crosshead 9, hydraulically activated support elements 10 are provided on the side of gap 7, which are arranged along a mantle line, several in a row, and are structured with a cylinder chamber 12 that is supplied with hydraulic fluid through stationary crosshead 9, in the manner of piston/cylinder units.

Support elements 10 rest against inside circumference 11 of hollow roller 8 with hydraulic bearing pockets, and operates to transfer force against this inside circumference. Stationary crosshead 9 can bend within the hollow roller 8 under the line stress caused by support elements 10, so that the hollow roller 8 is free, e.g., maintains a certain progression independent of the stress.

As already mentioned, the ultrasound treatment causes a local temperature increase in at least one of fabrics 1, 1′. The temperature increase is caused by the vibrations of sonotrode 2, and is limited, in terms of its increase over time, by the amount of ultrasound energy that can be, e.g., melting temperature.

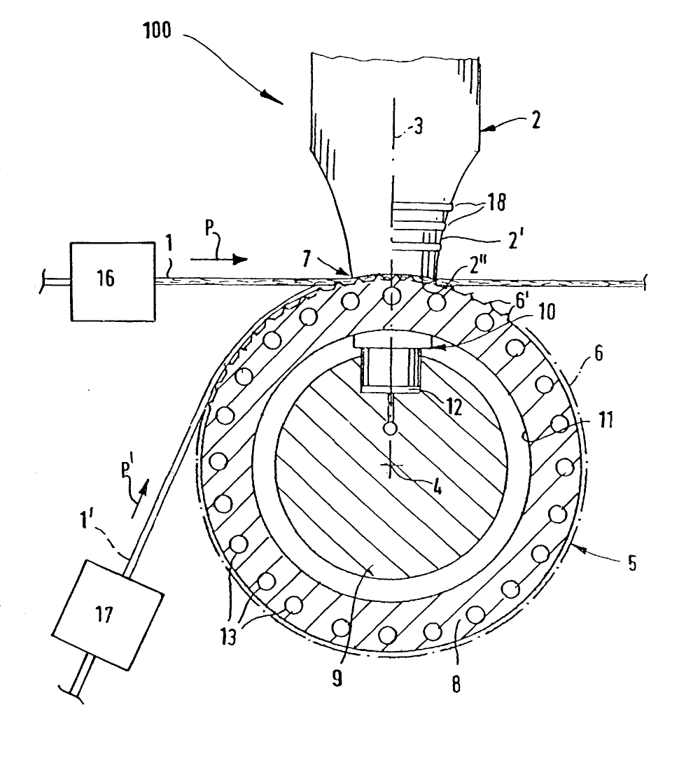

In order to achieve the required local plastification more quickly and/or more uniformly, the present invention may employ at least one of several measures, which, for the purpose of illustration only, are shown at the same time in FIG. 1.

According to one embodiment, the present invention provides a device 16 configuration to perform a pretreating step prior to working gap 7. Device 16 can include an application unit for applying powdered, viscous, liquid and/or gaseous agents to fabric 1, and/or a unit for local ion irradiation of fabric 1.

According to another embodiment, the present invention may also provide another device 17, the structure of which can correspond to that of device 16, which serves for pretreatment of fabric 1′.

To increase the amount of energy introduced into fabrics 1, 1′ to be treated in working gap 7, hollow roller 8 is provided with so-called peripheral bores 13 in the exemplary embodiment. The peripheral bores 13 can hold heating elements, not shown in the drawing, or a fluid heating medium can be passed through them. It is understood that any other known methods for heating hollow roller 8 can also be used, such as heating via the hydraulic fluid of support elements 10, inductive heating from the inside or outside, and the like. Because of being heated, peaks 6′ of engraving 6 transfer additional heat to the material of fabric 1′ in working gap 7, so that the temperature increase caused by sonotrode 2 reaching the desired temperature more rapidly at these points.

Accordingly to another embodiment, the present invention also provides lower end 2′ of sonotrode 2 with heating elements 18, which transfer their heat to lower end 2 by conduction. These may be electrical heating coils or the like.

### EXAMPLES

The following experiment was conducted with a device according to the present invention:

Three fabrics in the form of a layering of nonwoven fabric/film/nonwoven fabric, to be bonded together, were passed through the working gap. First, treatment was carried out in a conventional manner, i.e. without pretreatment of at least one of the fabrics before it passed through the working gap. At a specific predetermined ultrasound output, it was possible to achieve a maximum processing speed of 45 m/min while maintaining the criteria predetermined for adhesion of the layers and closeness of the laminate.

Keeping the ultrasound output the same, water in an amount of 1.7 ml/m² was applied to the layer of nonwoven fabric facing the sonotrode, before it passed through the working gap, in accordance with the present invention. By employing this step, the lamination speed was increased to 60 m/min, while still maintaining the criteria for adhesion and closeness. The drive momentum required for driving the counter-roller decreased by 20%. Also, the pressing force with which the sonotrode presses the fabric to be treated against the counter-roller was able to be reduced.

What is claimed is:

1. A method for ultrasound treatment of at least one fabric, wherein the at least one fabric is made of thermoplastic material, the method comprising the steps of:
pretreating the at least one fabric;
passing the at least one fabric through a working gap, the working gap formed between at least one sonotrode connected to at least one ultrasound vibration unit, and a counter-tool; and
in the working gap, exposing the at least one fabric to an ultrasound treatment.

2. The method according to claim 1, wherein the pretreating step includes the substep of applying an agent that activates at least one surface of the at least one fabric.

3. The method according to claim 1, wherein the pretreating step includes the substep of ion irradiation.

4. The method according to claim 1, wherein the pretreating step includes the substep of applying an agent that have an influence on the energy of the ultrasound effect in the working gap.

5. The method according to claim 4, wherein the agent includes a liquid having a boiling point that corresponds to a plastification temperature of the at least one fabric.

6. The method according to claim 1, wherein the pretreating step includes the substep of applying an agent that influences the friction between the at least one sonotrode and the at least one fabric.

7. The method according to claim 1, wherein the pretreating step includes the substep of applying an agent that cools the at least one sonotrode and/or the counter-tool as the at least one fabric passes through the working gap.

8. A device for ultrasound treatment of at least one fabric being made of thermoplastic material, the device comprising:
at least one sonotrode connected to at least one ultrasound vibration unit;
a counter-tool that forms a working gap with the at least one sonotrode;
means for passing the at least one fabric through the working gap; and
at least one pretreating device for pretreating the at least one fabric, wherein the at least one pretreating device is provided upstream from the working gap.

9. The device according to claim 8, wherein the pretreating device includes at least one application unit for applying at least one of powdered, viscous, liquid and gaseous agents to the at least one fabric.

10. The device according to claim 8, wherein the pretreating device includes a unit for providing ion irradiation of the at least one fabric.
